(19) United States
(12) Patent Application Publication
(10) Pub. No.: US 2026/0160693 A1
(43) Pub. Date: Jun. 11, 2026

(54) ENZYME MEASUREMENT METHOD, MICROCHAMBER ARRAY, KIT, METHOD FOR CAPTURING RAMAN SCATTERING IMAGE, AND METHOD FOR MEASURING TARGET MOLECULE

(71) Applicant: Riken, Wako-shi (JP)

(72) Inventors: Rikiya Watanabe, Wako-shi (JP); Jun Ando, Wako-shi (JP)

(21) Appl. No.: 18/716,886

(22) PCT Filed: Dec. 8, 2022
(86) PCT No.: PCT/JP2022/045297

§ 371 Date: Jun. 5, 2024

(30) Foreign Application Priority Data
Dec. 8, 2021 (JP) 2021-199642

(51) Int. Cl. G01N 21/65

(52) U.S. Cl. CPC G01N 21/658; G01N 2333/918; G01N 2333/928; G01N 2333/966

(57) ABSTRACT

An enzyme measurement method including preparing a mixed liquid including an enzyme and a selective substrate for the enzyme; preparing a microchamber array with immobilized metal nanostructures, the microchamber array having multiple microchambers in which metal nanostructures are immobilized; sealing each of the plurality of microchambers with the mixed liquid so that one or fewer molecules of the enzyme is present in each of the multiple microchambers; and illuminating the microchamber array with immobilized metal nanostructures with excitation light, and measuring the number of microchambers where a surface-enhanced Raman scattering intensity derived from an enzyme reaction product of the selective substrate or from the selective substrate has changed to a preset value or more, or is a preset threshold value or more or the threshold value or less.

### TECHNICAL FIELD

The present invention relates to an enzyme measurement method, a microchamber array, a kit, a method for capturing a Raman scattering image, and a method for measuring a target molecule. Priority is claimed on Japanese Patent Application No. 2021-199642, filed on Dec. 8, 2021, the content of which is incorporated herein by reference.

### BACKGROUND ART

Enzymes change the structure of a substrate molecule through a reaction such as hydrolysis and transfer. There are thousands of kinds of enzymes in a living body, and they are responsible for functions such as metabolism, absorption, and signal transduction. A bodily fluid such as blood, saliva, and urine includes trace amounts of enzymes produced in organs, and in a case where a specific organ dysfunctions, an activity value of the relevant enzyme in the body fluid is also decreased. In a case where an enzyme in a cell leaks into a body fluid such as blood due to inflammation of an organ, degeneration of a nerve cell, or the like, the activity of the enzyme is enhanced. Such changes in enzyme activity in the body fluid are correlated with the progression of various diseases, and so they are useful markers in the early and non-invasive diagnosis of certain diseases.

Patent Document 1 discloses the detection of enzyme activity at a single-molecule level using a microchamber having a femtoliter order size.

A problem with attempting to expand the range of diseases that can be diagnosed by enzyme activity lies in the technology used to measure enzyme activity. In the related art, for the measurement of enzyme activity in a sample, a labeled substrate that exhibits a fluorescence or a color reaction with an enzyme reaction was used. This is an important method for measuring enzyme activity with high sensitivity, but on the other hand, a bulky label hinders the enzyme reaction and there exist many enzymes whose activity is difficult to measure. Furthermore, a plurality of kinds of enzymes react with a labeled substrate, leading to many cases where it is difficult to isolate specific enzymes contributing to a disease from a group of enzymes that coexist. There is a need for the development of a new analysis technology, by which an enzyme can be detected without labeling and with high sensitivity, and a plurality of kinds of enzymes can be accurately identified.

As a method for quantifying the enzyme activity without labeling, Raman scattering spectroscopy, in particular, surface-enhanced Raman scattering (SERS) spectroscopy, which is expected to be highly sensitive, is promising. SERS is highly sensitive vibrational spectroscopy using a light-enhanced field formed in a metal nanostructure. In a case where a metal nanostructure having a smaller size than the wavelength is irradiated with light, a localized surface plasmon, which is a collective excitation of electrons, is induced. Here, in a case where an interval between the metal nanostructures is narrowed, the plasmons interact with each other and an extremely strongly enhanced electric field is formed between the metal nanostructures. Furthermore, in the SERS spectroscopy, in addition to the electric field enhancement effect, a chemical effect derived from the interaction between the metal and the molecule is also observed. Since the signal light intensity is significantly improved by the electric field enhancement effect and the chemical effect, the SERS spectroscopy is promising for increasing the sensitivity of the Raman scattering spectroscopy. Furthermore, a line width of the scattering spectrum observed in the SERS spectroscopy is narrower than that of the fluorescence emission spectrum. Therefore, it can also be expected that a large number of enzyme activities can be measured in a plurality of units at the same time by distinguishing reaction products of a plurality of enzymes without overlapping of the spectra. However, since close control of the metal nanostructures is required and there is a problem in quantitativeness and reproducibility, in SERS spectroscopy in which a conventional scattering intensity is taken on the vertical axis, it is difficult to capture a reaction product exhibited by a trace amount of an enzyme in a sample and to quantitatively discuss the enzyme concentration in a low-concentration region.

### CITATION LIST

### Patent Document

### Patent Document 1

Japanese Unexamined Patent Application, First Publication No. 2004-309405

### SUMMARY OF INVENTION

### Technical Problem

The present invention has been made in view of the above circumstances, and an object of the present invention is to provide a technology for measuring an enzyme in a sample without labeling and with excellent sensitivity.

### Solution to Problem

The present invention includes the following aspects.
[1] An enzyme measurement method including:
a mixed liquid preparation step in which a mixed liquid including an enzyme and a selective substrate for the enzyme is prepared;
an array preparation step in which a microchamber array with immobilized metal nanostructures is prepared, the microchamber array having a plurality of microchambers in which metal nanostructures are immobilized;
a mixed liquid sealing step in which each of the plurality of microchambers is sealed with the mixed liquid so that one or fewer molecules of the enzyme are present in each of the plurality of microchambers; and
a bright spot counting step in which the microchamber array with immobilized metal nanostructures is illuminated with excitation light, and the number of microchambers where a surface-enhanced Raman scattering intensity derived from an enzyme reaction product of the selective substrate or from the selective substrate has changed to a preset value or more, or is a preset threshold value or more or the threshold value or less is measured,
in which the enzyme reaction product has a different structure from the selective substrate, and the enzyme reaction product and the selective substrate are distinguishable by a Raman peak.
[2] An enzyme measurement method, including:
a mixed liquid preparing step in which a mixed liquid including an enzyme and a selective substrate for the enzyme is prepared;
an array preparing step in which a microchamber array with immobilized metal nanostructures is prepared, the microchamber array having a plurality of microchambers in which metal nanostructures are immobilized;
a mixed liquid sealing step in which each of the plurality of microchambers is sealed with the mixed liquid so that one or fewer molecules of the enzyme is present in each of the plurality of microchambers; and
a temporal change measuring step in which the microchamber array with immobilized metal nanostructures is illuminated with excitation light, and a surface-enhanced Raman scattering intensity derived from an enzyme reaction product of the selective substrate or from the selective substrate is measured over time for each of the plurality of microchambers,
in which the enzyme reaction product has a different structure from the selective substrate, and the enzyme reaction product and the selective substrate are distinguishable by a Raman peak.
[3] An enzyme measurement method, including:
a mixed liquid preparing step in which a mixed liquid including a plurality of kinds of enzymes and a plurality of kinds of selective substrates corresponding to the plurality of kinds of the enzymes is prepared;
an array preparing step in which a microchamber array with immobilized metal nanostructures is prepared, the microchamber array having a plurality of microchambers in which metal nanostructures are immobilized;
a mixed liquid sealing step in which each of the plurality of microchambers is sealed with the mixed liquid so that at least any one type of one or fewer molecules of the plurality of kinds of the enzymes is present in each of the plurality of microchambers; and
a bright spot counting step in which the microchamber array with immobilized metal nanostructures is illuminated with excitation light, and the number of microchambers where a surface-enhanced Raman scattering intensity derived from enzyme reaction products of the selective substrates or from the selective substrates has changed to a preset value or more, or is a preset threshold value or more or the threshold value or less is measured,
in which the enzyme reaction products have different structures from the selective substrates, and the enzyme reaction products and the selective substrates are distinguishable by a Raman peak, and
a plurality of kinds of the enzyme reaction products have different structures from each other, and the plurality of kinds of the enzyme reaction products or the selective substrates are distinguishable by the Raman peak.
[4] An enzyme measurement method, including:
a mixed liquid preparing step in which a mixed liquid including a plurality of kinds of enzymes and a plurality of kinds of selective substrates corresponding to the plurality of kinds of the enzymes is prepared;
an array preparing step in which a microchamber array with immobilized metal nanostructures is prepared, the microchamber array having a plurality of microchambers in which metal nanostructures are immobilized;
a mixed liquid sealing step in which each of the plurality of microchambers is sealed with the mixed liquid so that at least any one type of one or fewer molecules of the plurality of kinds of the enzymes is present in each of the plurality of microchambers; and
a temporal change measuring step in which the microchamber array with immobilized metal nanostructures is illuminated with excitation light, and a surface-enhanced Raman scattering intensity derived from enzyme reaction products of the selective substrates or from the selective substrates is measured over time for each of the plurality of microchambers,
in which the enzyme reaction products have different structures from the selective substrates, and the enzyme reaction products and the selective substrates are distinguishable by a Raman peak, and
a plurality of kinds of the enzyme reaction products have different structures from each other, and the plurality of kinds of the enzyme reaction products and the selective substrates are distinguishable by the Raman peak.
[5] An enzyme measurement method, including:
a mixed liquid preparing step in which a mixed liquid including an enzyme, a selective substrate for the enzyme, and a metal nanostructure is prepared;
a droplet dividing step in which the mixed liquid is divided into a plurality of droplets so that one or less molecule of the enzyme is included in the droplet; and
a bright spot counting step in which the plurality of droplets are illuminated with excitation light, and the number of droplets where a surface-enhanced Raman scattering intensity derived from an enzyme reaction product of the selective substrate or from the selective substrate has changed to a preset value or more, or is a preset threshold value or more or the threshold value or less is measured,
in which the enzyme reaction product has a different structure from the selective substrate, and the enzyme reaction product and the selective substrate are distinguishable by a Raman peak.
[6] An enzyme measurement method, including:
a mixed liquid preparing step in which a mixed liquid including an enzyme, a selective substrate for the enzyme, and a metal nanostructure is prepared;
a droplet dividing step in which the mixed liquid is divided into a plurality of droplets so that one or less molecule of the enzyme is included in the droplet; and
a temporal change measuring step in which the plurality of droplets are illuminated with excitation light, and a surface-enhanced Raman scattering intensity derived from an enzyme reaction product of the selective substrate or from the selective substrate is measured over time for each of the plurality of droplets,
in which the enzyme reaction product has a different structure from the selective substrate, and the enzyme reaction product and the selective substrate are distinguishable by a Raman peak.
[7] An enzyme measurement method, including:
a mixed liquid preparing step in which a mixed liquid including a plurality of kinds of enzymes, a plurality of kinds of selective substrates corresponding to the plurality of kinds of the enzymes, and a metal nanostructure is prepared;
a droplet dividing step in which the mixed liquid is divided into a plurality of droplets so that at least any one type of one or less molecule of the plurality of kinds of the enzymes is included in the droplet; and
a bright spot counting step in which the plurality of droplets are illuminated with excitation light, and the number of droplets where a surface-enhanced Raman scattering intensity derived from enzyme reaction products of the selective substrates or from the selective substrates has changed to a preset value or more, or is a preset threshold value or more or the threshold value or less is measured,
in which the enzyme reaction products have different structures from the selective substrates, and the enzyme reaction products and the selective substrates are distinguishable by a Raman peak, and
a plurality of kinds of the enzyme reaction products have different structures from each other, and the plurality of kinds of the enzyme reaction products or the selective substrates are distinguishable by the Raman peak.
[8] An enzyme measurement method including:
a mixed liquid preparing step in which a mixed liquid including a plurality of kinds of enzymes, a plurality of kinds of selective substrates corresponding to the plurality of kinds of the enzymes, and a metal nanostructure is prepared;
a droplet dividing step in which the mixed liquid is divided into a plurality of droplets so that at least any one type of one or less molecule of the plurality of kinds of the enzymes is included in the droplet; and
a temporal change measuring step in which the plurality of droplets are illuminated with excitation light, and a surface-enhanced Raman scattering intensity derived from enzyme reaction products of the selective substrates or from the selective substrates is measured over time for each of the plurality of droplets,
in which the enzyme reaction products have different structures from the selective substrates, and the enzyme reaction products and the selective substrates are distinguishable by a Raman peak, and
a plurality of kinds of the enzyme reaction products have different structures from each other, and the plurality of kinds of the enzyme reaction products or the selective substrates are distinguishable by the Raman peak.
[9] The enzyme measurement method according to any one of [1] to [4],
in which in the bright spot counting step or the temporal change measuring step, the microchamber array with immobilized metal nanostructures where each microchamber is sealed with the mixed liquid is illuminated with wide-field illumination, a Raman scattering image is acquired in a wavelength band of the Raman peak of the enzyme reaction product or the selective substrate, using a narrow line-width bandpass filter adapted to a position of the Raman peak, and a surface-enhanced Raman scattering light intensity and a temporal change in the intensity of each microchamber are quantified.
[10] The enzyme measurement method according to [9],
in which Raman scattering images are acquired in a top wavelength band of the Raman peak of the enzyme reaction product or the selective substrate and in the bottom wavelength band of the Raman peak, and the surface-enhanced Raman scattering light intensity and the temporal change in the intensity of each microchamber are quantified by taking a difference between the two images.
[11] The enzyme measurement method according to any one of [5] to [8],
in which in the bright spot counting step or the temporal change measuring step, the plurality of droplets obtained by dividing the mixed liquid are illuminated with wide-field illumination, a Raman scattering image is acquired in a wavelength band of the Raman peak of the enzyme reaction product or the selective substrate, using a narrow line-width bandpass filter adapted to a position of the Raman peak, and a surface-enhanced Raman scattering light intensity of each droplet is quantified.
[12] The enzyme measurement method according to [11],
in which Raman scattering images are acquired in a top wavelength band of the Raman peak of the enzyme reaction product or the selective substrate and in the bottom wavelength band of the Raman peak, and the surface-enhanced Raman scattering light intensity of each droplet is quantified by taking a difference between the two images.
[13] The enzyme measurement method according to any one of [1] to [12],
in which the enzyme reaction product has a thiol group.
[14] The enzyme measurement method according to any one of [1] to [13],
in which the metal nanostructure is an aggregate of metal nanoparticles.
[15] The enzyme measurement method according to any one of [1] to [14],
in which the enzyme is at least one selected from the group consisting of acetylcholinesterase, butyrylcholinesterase, phospholipase, elastase, and amylase.
[16] The enzyme measurement method according to [15],
in which a selective substrate for the acetylcholinesterase is MATP+ and a selective substrate for the butyrylcholinesterase is butyrylthiocholine.
[17] A microchamber array including:
a plurality of microchambers in which metal nanostructures are immobilized.
[18] The microchamber array according to [17],
in which the metal nanostructure is an aggregate of metal nanoparticles.
[19] A kit including:
the microchamber array according to [17] or [18]; and
a protocol that describes a procedure of the enzyme measurement method according to any one of [1] to [4], [9], [10], and [13] to [16].
[20] A method for capturing a Raman scattering image, the method including:
irradiating a sample with laser light expanded over an entire visual field by matching a transmission wavelength band of a narrow line-width bandpass filter to the top of a Raman peak of a target molecule to capture a Raman scattering image with a two-dimensional photodetector during the laser irradiation.
[21] The method for capturing a Raman scattering image according to [20], the method further including:
matching the transmission wavelength band of the narrow line-width bandpass filter to the bottom of the Raman peak of the target molecule.
[22] The method for capturing a Raman scattering image according to [20] or [21],
in which target molecules are arranged in a plurality of microchambers of a microchamber array having the plurality of microchambers.
[23] The method for capturing a Raman scattering image according to [22],
in which metal nanostructures are immobilized in the plurality of microchambers.
[24] The method for capturing a Raman scattering image according to [20] or [21],
in which the target molecules are arranged on a metal nanostructure.
[25] A method for measuring a target molecule using Raman scattering, the method including:
irradiating a sample with laser light expanded over an entire visual field by matching a transmission wavelength band of a narrow line-width bandpass filter to the top of a Raman peak of a target molecule to capture a Raman scattering image with a two-dimensional photodetector during the laser irradiation; and
extracting a density distribution of the target molecule from the obtained Raman scattering image.
[26] The method for measuring a target molecule according to [25], the method further including:
matching the transmission wavelength band of the narrow line-width bandpass filter to the bottom of the Raman peak of the target molecule.
[27] The method for measuring a target molecule according to [25] or [26],
in which the density distribution of the target molecule is extracted by taking a difference between Raman scattering images captured in the transmission wavelength band of the top and the transmission wavelength band of the bottom of the Raman peak of the target molecule.
[28] The method for measuring a target molecule according to any one of [25] to [27],
in which target molecules are arranged in a plurality of microchambers of a microchamber array having the plurality of microchambers.
[29] The method for measuring a target molecule according to [28],
in which metal nanostructures are immobilized in the plurality of microchambers.
[30] The method for measuring a target molecule according to any one of [25] to [27],
in which the target molecules are arranged on a metal nanostructure.

In addition, the present invention includes the following aspects.
(1) An enzyme measurement method including:
a mixed liquid preparation step in which a mixed liquid including an enzyme and a selective substrate for the enzyme is prepared;
an array preparation step in which a microchamber array with immobilized metal nanostructures is prepared, the microchamber array having a plurality of microchambers in which metal nanostructures are immobilized;
a mixed liquid sealing step in which each of the plurality of microchambers is sealed with the mixed liquid so that one or fewers molecules of the enzyme is present in each of the plurality of microchambers; and
a bright spot counting step in which the microchamber array with immobilized metal nanostructures is illuminated with excitation light, and the number of microchambers where a surface-enhanced Raman scattering intensity derived from an enzyme reaction product of the selective substrate or from the selective substrate has changed to a preset value or more, or is a preset threshold value or more or the threshold value or less is measured; or
a temporal change measuring step in which the microchamber array with immobilized metal nanostructures is illuminated with excitation light, and a surface-enhanced Raman scattering intensity derived from an enzyme reaction product of the selective substrate or from the selective substrate is measured over time for each of the plurality of microchambers,
in which the enzyme reaction product has a different structure from the selective substrate, and the enzyme reaction product and the selective substrate are distinguishable by a Raman peak.
(2) The enzyme measurement method according to (1),
in which in the mixed liquid preparation step, a mixed liquid including a plurality of kinds of enzymes and a plurality of kinds of selective substrates corresponding to the plurality of kinds of the enzymes is prepared,
in the mixed liquid sealing step, each of the plurality of microchambers is sealed with the mixed liquid so that at least any one type of one or fewer molecules of the plurality of kinds of the enzymes is present in each of the plurality of microchambers, and
a plurality of kinds of the enzyme reaction products have different structures from each other, and the plurality of kinds of the enzyme reaction products or the selective substrates are distinguishable by the Raman peak.
(3) An enzyme measurement method including:
a mixed liquid preparation step in which a mixed liquid including an enzyme, a selective substrate for the enzyme, and a metal nanostructure is prepared;
a droplet dividing step in which the mixed liquid is divided into a plurality of droplets so that one or fewer molecules of the enzyme is included in the droplet; and
a bright spot counting step in which the plurality of droplets are illuminated with excitation light, and the number of droplets where a surface-enhanced Raman scattering intensity derived from an enzyme reaction product of the selective substrate or from the selective substrate has changed to a preset value or more, or is a preset threshold value or more or the threshold value or less is measured; or
a temporal change measuring step in which the plurality of droplets are illuminated with excitation light, and a surface-enhanced Raman scattering intensity derived from an enzyme reaction product of the selective substrate or from the selective substrate is measured over time for each of the plurality of droplets,
in which the enzyme reaction product has a different structure from the selective substrate, and the enzyme reaction product and the selective substrate are distinguishable by a Raman peak.
(4) The enzyme measurement method according to (3),
in which in the mixed liquid preparing step, a mixed liquid including a plurality of kinds of enzymes and a plurality of kinds of selective substrates corresponding to the plurality of kinds of the enzymes is prepared,
in the droplet dividing step, the mixed liquid is divided into a plurality of droplets so that at least any one type of one or fewer molecules of the plurality of kinds of the enzymes is included in the droplet, and
a plurality of kinds of the enzyme reaction products have different structures from each other, and the plurality of kinds of the enzyme reaction products and the selective substrates are distinguishable by the Raman peak.
(5) The enzyme measurement method according to (1) or (2),
in which in the bright spot counting step or the temporal change measuring step, the microchamber array with immobilized metal nanostructures where each microchamber is sealed with the mixed liquid is illuminated with wide-field illumination, a Raman scattering image is acquired in a wavelength band of the Raman peak of the enzyme reaction product or the selective substrate, using a narrow line-width bandpass filter adapted to a position of the Raman peak, and a surface-enhanced Raman scattering light intensity and a temporal change in the intensity of each microchamber are quantified.
(6) The enzyme measurement method according to (5),
in which Raman scattering images are acquired in a top wavelength band of the Raman peak of the enzyme reaction product or the selective substrate and in the bottom wavelength band of the Raman peak, and the surface-enhanced Raman scattering light intensity and the temporal change in the intensity of each microchamber are quantified by taking a difference between the two images.
(7) The enzyme measurement method according to (3) or (4),
in which in the bright spot counting step or the temporal change measuring step, the plurality of droplets obtained by dividing the mixed liquid are illuminated with wide-field illumination, a Raman scattering image is acquired in a wavelength band of the Raman peak of the enzyme reaction product or the selective substrate, using a narrow line-width bandpass filter adapted to a position of the Raman peak, and a surface-enhanced Raman scattering light intensity of each droplet is quantified.
(8) The enzyme measurement method according to (7),
in which Raman scattering images are acquired in a top wavelength band of the Raman peak of the enzyme reaction product or the selective substrate and in the bottom wavelength band of the Raman peak, and the surface-enhanced Raman scattering light intensity of each droplet is quantified by taking a difference between the two images.
(9) The enzyme measurement method according to any one of (1) to (8),
in which the enzyme reaction product has a thiol group.
(10) The enzyme measurement method according to any one of (1) to (9),
in which the metal nanostructure is an aggregate of metal nanoparticles.
(11) The enzyme measurement method according to any one of (1) to (10),
in which the enzyme is at least one selected from the group consisting of acetylcholinesterase, butyrylcholinesterase, phospholipase, elastase, and amylase.
(12) The enzyme measurement method according to (11),
in which a selective substrate for the acetylcholinesterase is MATP+ and a selective substrate for the butyrylcholinesterase is butyrylthiocholine.
(13) A microchamber array including:
a plurality of microchambers in which metal nanostructures are immobilized.
(14) The microchamber array according to (13), in which the metal nanostructure is an aggregate of metal nanoparticles.
(15) A kit including:
the microchamber array according to (13) or (14); and
a protocol that describes a procedure of the enzyme measurement method according to any one of (1), (2), (5), (6), and (9) to (12).
(16) A method for capturing a Raman scattering image, the method including:
irradiating a sample with laser light expanded over an entire visual field by matching a transmission wavelength band of a narrow line-width bandpass filter to the top of a Raman peak of a target molecule to capture a Raman scattering image with a two-dimensional photodetector during the laser irradiation.
(17) The method for capturing a Raman scattering image according to (16), the method further including:
matching the transmission wavelength band of the narrow line-width bandpass filter to the bottom of the Raman peak of the target molecule.
(18) The method for capturing a Raman scattering image according to (16) or (17),
in which target molecules are arranged in a plurality of microchambers of a microchamber array having the plurality of microchambers.
(19) The method for capturing a Raman scattering image according to (18),
in which metal nanostructures are immobilized in the plurality of microchambers.
(20) The method for capturing a Raman scattering image according to (16) or (17),
in which the target molecules are arranged on a metal nanostructure.
(21) A method for measuring a target molecule using Raman scattering, the method including:
irradiating a sample with laser light expanded over an entire visual field by matching a transmission wavelength band of a narrow line-width bandpass filter to the top of a Raman peak of a target molecule to capture a Raman scattering image with a two-dimensional photodetector during the laser irradiation; and
extracting a density distribution of the target molecule from the obtained Raman scattering image.
(22) The method for measuring a target molecule according to (21), the method further including:
matching the transmission wavelength band of the narrow line-width bandpass filter to the bottom of the Raman peak of the target molecule.
(23) The method for measuring a target molecule according to (21) or (22),
in which the density distribution of the target molecule is extracted by taking a difference between Raman scattering images captured in the transmission wavelength band of the top and a transmission wavelength band of the bottom of the Raman peak of the target molecule.
(24) The method for measuring a target molecule according to any one of (21) to (23),
in which target molecules are arranged in a plurality of microchambers of a microchamber array having the plurality of microchambers.
(25) The method for measuring a target molecule according to (24),
in which metal nanostructures are immobilized in the plurality of microchambers.
(26) The method for measuring a target molecule according to any one of (21) to (23),
in which the target molecules are arranged on a metal nanostructure.

### Advantageous Effects of Invention

According to the present invention, it is possible to provide a technology for detecting an enzyme in a sample without labeling and with excellent sensitivity.

### BRIEF DESCRIPTION OF DRAWINGS

FIG. 1 is a schematic configuration view of an example of a high-speed Raman imaging apparatus used for measurement of an SERS chip.

FIG. 2 is an approximate example of a measurement time for each illumination form.

FIG. 3 is a schematic view of an example of an SERS chip in which metal nanostructures are immobilized.

FIG. 4 is a schematic cross-sectional view showing each step of a method for producing an SERS chip.

FIG. 5 is a scattering image of an SERS chip in which silver nanoparticles are immobilized in a microchamber array used in Examples.

FIG. 6 is an optical-system schematic view of a wide-field Raman microscope used in Examples.

FIG. 7 is an image on the left of FIG. 7, which is an SERS image of a sample in Example in which a mixed liquid of acetylcholinesterase (AChE) and acetylthiocholine is filled in an SERS chip. The graph shown in the center of FIG. 7 is an SERS spectrum in the chamber A and the chamber B in the SERS image. The figure shown on the right in FIG. 7 is a schematic view of the decomposition of acetylthiocholine by acetylcholinesterase and the SERS measurement of a decomposition product. The SERS image and the SERS spectrum were acquired with a slit-scanning Raman microscope under the conditions of 100 pM of acetylcholinesterase and 2 mM of acetylthiocholine.

FIG. 8 is a graph showing a relationship between the acetylcholinesterase (AChE) concentration and the number of bright spots in Examples. The number of bright spots was acquired with a slit-scanning Raman microscope.

FIG. 9 is an SERS image of a sample in which a mixed liquid of acetylcholinesterase (AChE) and acetylthiocholine is filled in an SERS chip in Examples. The SERS image was acquired with a wide-field Raman microscope under the conditions of 10 pM of acetylcholinesterase and 2 mM of acetylthiocholine.

FIG. 10 is a graph showing a relationship between the acetylcholinesterase (AChE) concentration and the number of bright spots in Examples. The number of bright spots was acquired with a wide-field Raman microscope. The dotted line in the graph indicates a value obtained by adding three times the standard deviation to an average value of the number of bright spots in a case of 0 M of acetylcholinesterase. An intersection between the dotted line and the solid line is regarded as a detection lower limit.

FIG. 11 shows an image on the upper left of FIG. 11, which is an SERS image of a sample in Example in which a mixed liquid of acetylcholinesterase (AChE), butyrylcholinesterase (BuChE), MATP+, and butyrylthiocholine is filled in an SERS chip. The graph shown in the lower left of FIG. 11 is an SERS spectrum in the chamber A and the chamber B in the SERS image. The figures shown in the upper right of FIG. 11 are a schematic view (left) of the decomposition of MATP+ by acetylcholinesterase (AChE) and the SERS measurement of the decomposition product, and a schematic view (right) of the decomposition of butyrylthiocholine by butyrylcholinesterase (BuChE) and the SERS measurement of the decomposition product. The SERS image and the SERS spectrum were acquired with a slit-scanning Raman microscope under the conditions of 100 pM of each of acetylcholinesterase and butyrylcholinesterase, and 1 mM of each of MATP+ and butyrylthiocholine.

### DESCRIPTION OF EMBODIMENTS

Hereinafter, embodiments of the present technology will be described in detail with reference to the accompanying drawings as appropriate. In the drawings, the same or corresponding parts are denoted by the same or corresponding reference numerals, and overlapping descriptions are omitted. Note that dimensional ratios in each drawing are exaggerated for the sake of explanation, and do not necessarily match the actual

### Raman Spectroscopic Imaging Apparatus

An example of a Raman spectroscopic imaging apparatus used in measurement of an SERS chip (a microchamber array in which a metal nanostructure is immobilized in each microchamber, the details of which will be described later) in the present technology will be described.

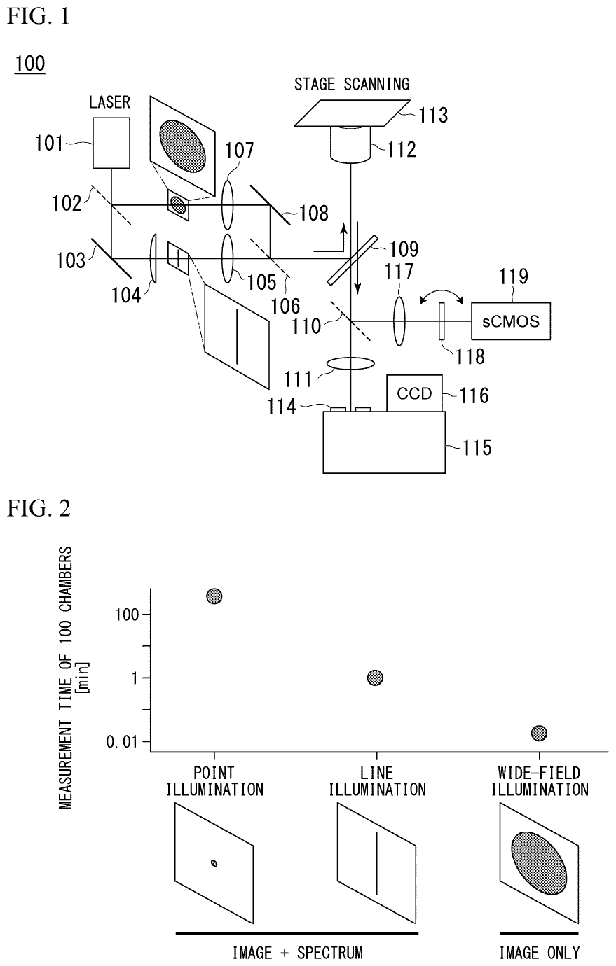

A Raman spectroscopic imaging apparatus 100 the configuration of which is schematically shown in FIG. 1 has a line illumination system and a wide-field illumination system.

In the line illumination system, a laser light (excitation laser) emitted from a laser light source 101 passes through a mirror 103→a cylindrical lens 104→a lens 105→a dichroic filter 109→an objective lens 112 in this order to illuminate a sample 113. The laser light from the laser light source 101 is formed into a line shape by the cylindrical lens 104. The Raman scattering light from the sample 113 passes through the objective lens 112, the dichroic filter 109, and a lens 111 in this order, and is imaged on a CCD 116 along a slit 114 of a spectroscope 115. In the line illumination system, the spectrum is detected in parallel to increase the speed.

In the wide-field illumination system, the laser light emitted from the laser light source 101 passes through a flip mirror 102→a lens 107, a mirror 108, a flip mirror 106→a dichroic filter 109→the objective lens 112 in this order to illuminate the sample 113. The Raman light from the sample 113 passes through the objective lens 112→the dichroic filter 109→a flip mirror 110→a lens 117→a narrow line-width bandpass filter 118 in this order, and is imaged on the sCMOS of a two-dimensional detector 119. The narrow line-width bandpass filter 118 adapted to the position of a Raman peak specific to a decomposition product of the substrate is arranged in an imaging optical system for wide-field illumination. By using the angle dependence of the transmission band, scattering images are each acquired at the top and the tail of the Raman peak of the decomposition product, and the SERS light intensity of each chamber is quantified from the difference.

FIG. 2 shows an approximate example of a measurement time for each illumination form. It is expected that 100 or more chambers per second can be analyzed by the wide-field illumination. In a case where an enzyme reaction product of the substrate is used as a sample, a scattering intensity derived from the enzyme reaction product can be selectively extracted by adjusting the angle of the narrow line-width bandpass filter.

### SERS Chip

Hereinafter, an example of a microchamber array (SERS chip) in which metal nanostructures are immobilized in microchambers, as used in the present technology, will be described. However, in the present technology, a droplet can be used instead of the microchamber array, but this will be described separately.

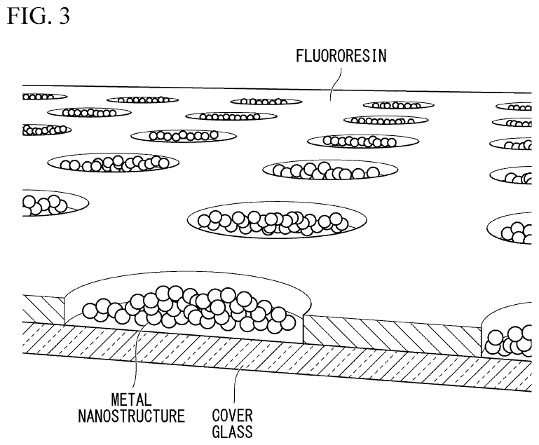

With the SERS chip according to the present technology, a uniform SERS light intensity can be obtained. The uniformity is ensured by uniformly forming the metal nanostructure in each chamber. A reason thereof is that a strong SERS light is generated in a fine gap of the metal nanostructure. The formation of the metal nanostructure in the chamber can be controlled and countless gap structures can be formed to stabilize the degree of amplification. In an example of the microchamber, the bottom surface is glass, and the periphery is made of a fluororesin and cylindrical. As shown in FIG. 3, it is preferable that the glass part of the bottom surface of the microchamber be chemically modified so that the metal nanostructure covers the entire region of the lower surface of the chamber. By optimizing the metals that constitute the metal nanostructure, the shape, the size, the formation conditions, the excitation wavelength, the chamber volume, and the like, the sensitivity and the uniformity can be further improved.

The above-described SERS chip can be produced, for example, as follows.

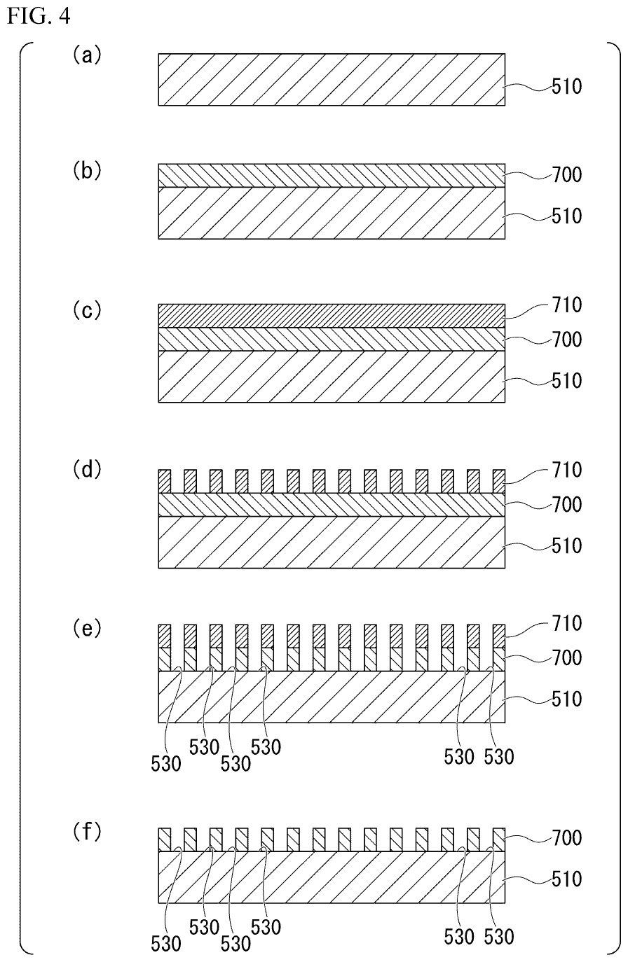

First, as shown in FIG. 4(a), a substrate 510 is prepared.

Examples of a material for the substrate 510 include glass and a resin.

The glass is not particularly limited. Examples of the glass include quartz glass, borosilicate glass, and soda lime glass.

Examples of the resin include polyethylene, polypropylene, polystyrene, polycarbonate, a cyclic polyolefin, and acryl. Among the resins, the polycarbonate is also used as a material for CDs and DVDs that can be mass-produced at low cost, and is also suitable from the viewpoint of producing a microchamber array at low cost.

As a material for the substrate 510, glass or polycarbonate is preferable, and glass is more preferable.

Subsequently, as shown in FIG. 4(b), a film 700 is laminated on a surface of the substrate 510.

Examples of a material for the film 700 include a fluorine-based resin, a cyclic polyolefin, and a silicone-based resin.

A thickness of the film 700 is not particularly limited, but can be appropriately set in consideration of the volume of the microchamber.

Subsequently, as shown in FIG. 4(c), a resist film 710 is laminated on a surface of the film 700. Subsequently, using a mask with the pattern of the microchamber array, the resist film 710 is exposed by irradiation with active energy rays with an exposure machine. Next, development is performed with a developer to remove the portion of the resist film 710, which forms the microchamber.

Subsequently, as shown in FIG. 4(e), the film 700 masked with the resist film 710 is etched to form a microchamber 530 in the film 700.

Subsequently, as shown in FIG. 4(f), the substrate is washed to remove the resist film 710, thereby obtaining an array of the microchambers 530. By the steps so far, a microchamber array having a plurality of microchambers can be obtained.

Next, the metal nanostructures are immobilized on the bottom surface of the well 530 of the manufactured microchamber array.

First, a cationic functional group is introduced into the bottom surface of the microchambers 530 of the microchamber array.

A dispersion of metal nanoparticles, and trifluoroacetic acid as an aggregation accelerator are mixed with each other, and the mixture is added dropwise to the microchambers to form an aggregate of the metal nanoparticles negatively charged on the bottom surface of the microchambers.

As a result, a microchamber array in which the metal nanostructure, which is an aggregate of the metal nanoparticles, is immobilized on the bottom surface of the microchambers is obtained.

A volume of the microchamber is not particularly limited, but is preferably 1 aL to 1 nL, and more preferably 1 fL to 1 pL. Furthermore, “a” (atto) is a prefix representing 10⁻¹⁸, “f” (femto) is a prefix representing 10⁻¹⁵, “p” (pico) is a prefix representing 10⁻¹², and “n” (nano) is a prefix representing 10⁻⁹.

In the above-described example, a case where an aggregate of the metal nanoparticles is used as the metal nanostructure has been described, but the present invention is not limited thereto. A highly localized electric field is present in the vicinity of the metal nanostructure, and thus, in a case where a molecule is present in this high-intensity localized electric field, the optical responsiveness of the molecule is significantly modulated. A specific example of such modulation is surface-enhanced Raman scattering (SERS). Therefore, examples of the metal nanostructure include a metal nanoparticle aggregate in which metal nanoparticles are aggregated in the presence of an aggregating agent, and a regular arrangement structure of a metal nanostructure in which a closest packing arrangement of polystyrene beads is used as a template. In addition, examples of the metal nanostructure also include a metal nanodot array based on an anodized porous alumina.

The type of metal of the metal nanostructure is not particularly limited, but is preferably at least one selected from the group consisting of silver, gold, copper, platinum, palladium, aluminum, and titanium, more preferably at least one selected from the group consisting of silver, gold, platinum, and palladium, still more preferably silver or gold, and even still more preferably silver. Two or more different kinds of metals may be used in combination. In addition, an alloy of two or more kinds of metals may be used. As the metal nanoparticles, core-shell type particles of two or more kinds of metals, or the like can also be used.

A shape of the metal nanoparticles in a case where the metal nanostructure is composed of the metal nanoparticles is not particularly limited, and examples thereof include a spherical shape, a sub-spherical shape, a rod shape, a cubic shape, an elliptical shape, a triangular shape, a biconical shape, and a star shape. Two or more kinds of metal nanoparticles having different shapes may be used in combination.

An average particle diameter of the primary particles of the metal nanoparticles is not particularly limited, but is preferably 1 to 1,500 nm, more preferably 1 to 500 nm, and still more preferably 10 to 100 nm. In addition, a volume of the primary particles of the metal nanoparticles is not particularly limited, but is preferably 1 nm 3 to 1μm³.

The metal nanoparticles may be an aggregate of metal nanoparticles, in which a plurality of metal nanoparticles are aggregated. The aggregate of metal nanoparticles can be produced, for example, by treating the metal nanoparticles (primary particles) with an aggregation accelerator such as trifluoroacetic acid to aggregate the metal nanoparticles.

Furthermore, the metal nanoparticles can be produced by a known method in the related art.

By using the metal nanoparticles as the aggregate, a large number of fine gaps between adjacent particle pairs are formed and the number of molecules present in the gap can be increased. Thus, Raman scattering is further enhanced, whereby the sensitivity is further improved.

The number of microchambers per microchamber array is not particularly limited, but is preferably 100 or more, more preferably 1,000 or more, and still more preferably 10,000 or more. An upper limit of the number of microchambers per microchamber array is not particularly limited, but is preferably 10,000,000 or less since it is preferable that it not take too much time to measure the brightness of the bright spots and count the bright spots.

### Method for Measuring Enzyme

In the enzyme measurement method of the present technology, the surface-enhanced Raman scattering intensity derived from the enzyme reaction product of the selective substrate or from the selective substrate is measured for each of the microreactive spaces (microchambers or droplets) with which one or less molecule of the enzyme, the selective substrate for the enzyme, and the metal nanostructure are filled, and the number of reactive spaces where the surface-enhanced Raman scattering intensity has changed to a preset value or more, or is a preset threshold value or more or the threshold value or less is measured. According to the enzyme measurement method of the present technology, it is possible to measure the enzyme concentration in a sample more quantitatively and with high sensitivity by capturing the action (decomposition of a substrate) of the enzyme for each of the molecules, using a microreactive space, and directly counting the number of enzyme molecules from the number of microreactive spaces where changes are observed.

Hereinafter, specific embodiments of the enzyme measurement method of the present technology will be described in detail.

### First Embodiment

A first embodiment of the enzyme measurement method of the present technology is an enzyme measurement method including a mixed liquid preparation step in which a mixed liquid including an enzyme and a selective substrate for the enzyme is prepared; an array preparation step in which a microchamber array with immobilized metal nanostructures is prepared, the microchamber array having a plurality of microchambers in which metal nanostructures are immobilized; a mixed liquid sealing step in which each of the plurality of microchambers is sealed with the mixed liquid so that one or fewer molecules of the enzyme is present in each of the plurality of microchambers; and a bright spot counting step in which the microchamber array with immobilized metal nanostructures is illuminated with excitation light, and the number of microchambers where a surface-enhanced Raman scattering intensity derived from an enzyme reaction product of the selective substrate or from the selective substrate has changed to a preset value or more, or is a preset threshold value or more or the threshold value or less is measured. Here, the enzyme reaction product has a different structure from the selective substrate, and the enzyme reaction product and the selective substrate are distinguishable by a Raman peak.

### Mixed Liquid Preparation Step

In the mixed liquid preparation step, a mixed liquid including an enzyme and a selective substrate for the enzyme is prepared.

Examples of the enzyme include acetylcholinesterase, butyrylcholinesterase, phospholipase, elastase, and amylase.

Acetylcholinesterase (AChE) is present in nerve tissues, red blood cells, and the like, and decomposes acetylcholine (ACh), which is one of neurotransmitters of cholinergic nerves (parasympathetic nerves, motor nerves, and central-to-ganglion sympathetic nerves), into choline. AChE itself is acetylated by Ach decomposition and inactivated, but deacetylation occurs in a few milliseconds to regain activity.

Butyrylcholinesterase (BuChE) is synthesized in the liver in humans, is present in blood serum and the like, and decomposes various choline esters including ACh.

The selective substrate for the enzyme has a different structure from an enzyme reaction product of the selective substrate, and is distinguishable from the enzyme reaction product by a Raman peak. Here, the enzyme reaction product has a molecular structure which can interact with the metal nanostructure.

The selective substrate for the enzyme can be selected as appropriate according to the type of the enzyme, and examples thereof include butyrylthiocholine (BTC) as the selective substrate for BuChE and MATP+ (1,1-dimethyl-4-acetylthiomethyl piperidinium) as the selective substrate for AChE. The hydrolysis products of BTC by BuchE are thiocholine and butyric acid, and the hydrolysis products of MATP+by AChE are 1,1-dimethyl-4-mercaptomethyl piperidinium and acetic acid. Thiocholine and 1,1-dimethyl-4-mercaptomethyl piperidinium are preferable since these have a thiol group (mercapto group) in the molecule, and are easily captured on a surface of the metal nanoparticles which will be described later. In addition, thiocholine and 1,1-dimethyl-4-mercaptomethyl piperidinium are also preferable since these are a combination of compounds which are easily distinguishable from the Raman scattering spectrum.

In the mixed liquid preparation step, water is preferable as a solvent or a dispersion medium of the mixed liquid. As the water, ultrapure water such as Milli-Q water and ultrafiltration water (UF water) is preferable, but water in which the enzyme and the selective substrate are dissolved or dispersed may be used as it is as the solvent or the dispersion medium of the mixed liquid.

In the mixed liquid preparing step, the mixed liquid may include a surfactant in addition to the enzyme, the selective substrate, and the solvent.

A type of the surfactant is not particularly limited as long as it does not inhibit a reaction between the enzyme and the selective substrate therefor, and examples of the surfactant include Triton X-100 (t-octylphenoxypolyethoxyethanol).

A concentration of the surfactant is not particularly limited as long as it is a concentration not inhibiting the reaction between the enzyme and the selective substrate therefor, and examples thereof include 1 to 500 μM in a mixed liquid.

The mixed liquid is used to adjust the number of enzyme molecules per one microchamber to one or less. In an appropriate case, the mixed liquid may be used after being diluted. As a solvent or a dispersion medium used for the dilution, water is preferable. As the water, ultrapure water such as Milli-Q water and ultrafiltration water (UF water) is preferable.

### Array Preparing Step

In the array preparing step, a microchamber array with immobilized metal nanostructures (SERS chip) in which the metal nanostructures are immobilized in a plurality of microchambers is prepared.

The SERS chip can be produced, for example, according to the above-described production method.

### Mixed Liquid Sealing Step

In the mixed liquid sealing step, the mixed liquid is filled in each of the plurality of microchambers of the SERS chip prepared in the array preparing step so that the number of molecules of the enzyme is one or less. That is, the number of molecules of the enzyme included in one microchamber is one or less. The mixed liquid prepared in the mixed liquid preparing step may be used after being diluted as suitable.

Examples of a method for filling the SERS chip with the mixed liquid include a method in which the mixed liquid is distributed to each microchamber and then filled by a layering oil or a liquid paraffin on the mixed liquid in the microchamber. In the above-described SERS chip, since the upper surface of the SERS chip is coated with a fluorine-based resin, the water repellency is high.

In the mixed liquid sealing step, a reaction product (enzyme reaction product) between the enzyme and the selective substrate therefor is generated. Since the volume of the mixed liquid is small, the enzyme reaction product in the mixed liquid is located in the vicinity of the metal nanostructure. In the present technology, by irradiating the metal nanostructure with excitation light, localized surface plasmon resonance (LSPR) occurs on the surface of the metal nanostructure. Due to an influence of the localization of the plasmon resonance, a strong electric field is generated in the vicinity of the surface of the nanoparticles, and a particularly strong electric field is induced in the vicinity of a contact part of the two nanoparticles. In the surface-enhanced Raman scattering (SERS), the Raman scattering intensity of a molecule close to the surface of the metal nanoparticles is enhanced by several orders of magnitude.

The enzyme reaction product may be present in the vicinity of the metal nanostructure, or may be adsorbed, bonded, or the like to the surface of the metal nanostructure. In particular, it is preferable to select a selective substrate so that the enzyme reaction product is bonded to the metal nanostructure, for example, so that the enzyme reaction product has a thiol group. In a case where the enzyme reaction product is bonded to the metal nanostructure, the Raman scattering light can be enhanced and the sensitivity can be further improved.

Examples of a method for filling the microchamber with the mixed liquid include filling the mixed liquid by an oil. Examples of the oil include inactive oils such as Fomblin, mineral oil, hexadecane, 3M Fluorinert FC-40, and 3M Fluorinert FC-70, but the oil is not limited thereto.

### Bright Spot Counting Step

In the bright spot counting step, the number of microchambers where the surface-enhanced Raman scattering intensity derived from the enzyme reaction product of the selective substrate or from the selective substrate has changed to a preset value or more, or is a preset threshold value or more or the threshold value or less is measured.

More specifically, the SERS chip is illuminated with wide-field illumination, and a Raman scattering image is acquired at the top of a Raman peak of the enzyme reaction product or the selective substrate, using a narrow line-width bandpass filter adapted to a position of the Raman peak, thereby quantifying the surface-enhanced Raman scattering light intensity of each microchamber.

Furthermore, a Raman scattering image may be acquired at the bottom of the Raman peak of the enzyme reaction product or the selective substrate, thereby quantifying the surface-enhanced Raman scattering light intensity from a difference between the top and the bottom.

The number of microchambers where the surface-enhanced Raman scattering intensity has changed to a preset value or more, or is a preset threshold value or more or the threshold value or less is measured.

The preset value or threshold value can be experimentally determined, for example, as a value which can distinguish two samples used, which are a sample including an enzyme and a selective substrate for the enzyme and a sample not including at least one of the enzyme and the selective substrate for the enzyme by measuring a surface-enhanced Raman scattering light intensity derived from an enzyme reaction product of the selective substrate or from the selective substrate. A method for determining the preset value or threshold value is not particularly limited, and for example, the preset value or threshold value can be determined by using a general statistical method. It is possible to determine whether or not the enzyme is included in the microchamber by comparing the preset value or threshold value with the surface-enhanced Raman scattering light intensity derived from the enzyme reaction product of the selective substrate or from the selective substrate, which was measured in the bright spot counting step.

The narrow line-width bandpass filter may be configured by one sheet of a narrow line-width bandpass filter, or the transmission band may be narrowed by combination of two or more sheets of bandpass filters.

In addition, the narrow line-width bandpass filter may adjust the transmission band by using the angle dependence of the transmission band.

### Modified Example of First Embodiment—Method for Measuring Plurality of Kinds of Enzymes

The first embodiment of the enzyme measurement method of the present technology may be an enzyme measurement method including a mixed liquid preparation step in which a mixed liquid including a plurality of kinds of enzymes and a plurality of kinds of selective substrates corresponding to the plurality of kinds of the enzymes is prepared; an array preparation step in which a microchamber array with immobilized metal nanostructures is prepared, the microchamber array having a plurality of microchambers in which metal nanostructures are immobilized; a mixed liquid sealing step in which the plurality of microchambers are sealed with the mixed liquid so that at least any one type of one or fewer molecules of the plurality of kinds of the enzymes is present in each of the plurality of microchambers; and a bright spot counting step in which the microchamber array with immobilized metal nanostructures is illuminated with excitation light, and the number of microchambers where a surface-enhanced Raman scattering intensity derived from enzyme reaction products of the selective substrates or from the selective substrates has changed to a preset value or more, or is a preset threshold value or more or the threshold value or less is measured. Here, the enzyme reaction products have different structures from the selective substrates, and the enzyme reaction products and the selective substrates are distinguishable by a Raman peak. Further, a plurality of kinds of the enzyme reaction products have different structures from each other, and the plurality of kinds of the enzyme reaction products or the selective substrates are distinguishable by the Raman peak.

A basic example of the above-described first embodiment is different in that in the mixed liquid preparation step, the mixed liquid including a plurality of kinds of enzymes and a plurality of kinds of selective substrates corresponding to the plurality of kinds of the enzymes is prepared; in the mixed liquid sealing step, the plurality of microchambers are sealed with the mixed liquid so that at least any one type of one or fewer molecules of the plurality of kinds of the enzymes is present in each of the plurality of microchambers; and in the bright spot measuring step, the plurality of kinds of the enzyme reaction products or the selective substrates are identified, but the other aspects are substantially the same as above.

### Second Embodiment

A second embodiment of the enzyme measurement method of the present technology includes a mixed liquid preparation step in which a mixed liquid including an enzyme and a selective substrate for the enzyme is prepared; an array preparation step in which a microchamber array with immobilized metal nanostructures is prepared, the microchamber array having a plurality of microchambers in which metal nanostructures are immobilized; a mixed liquid sealing step in which the plurality of microchambers are sealed with the mixed liquid so that one or fewer molecules of the enzyme is present in each of the plurality of microchambers; and a temporal change measuring step in which the microchamber array with immobilized metal nanostructures is illuminated with excitation light, and a surface-enhanced Raman scattering intensity derived from an enzyme reaction product of the selective substrate or from the selective substrate is measured over time for each of the plurality of microchambers. Here, the enzyme reaction product has a different structure from the selective substrate, and the enzyme reaction product and the selective substrate are distinguishable by a Raman peak.

In the second embodiment, the bright spot counting step of the first embodiment is changed to a temporal change measuring step in which a surface-enhanced Raman scattering intensity derived from the enzyme reaction product or from the selective substrate for each of the plurality of microchambers is measured over time. The other configurations are substantially the same as those of the first embodiment.

In the temporal change measuring step, the enzyme activity can be measured as a change in the scattering intensity per unit time by measuring the surface-enhanced Raman scattering intensity derived from the enzyme reaction product or from the selective substrate over time for each of the plurality of microchambers. By measuring the enzyme activity, for example, information on the multimerization degree of the enzyme can also be obtained.

### Modified Example of Second Embodiment

The second embodiment of the enzyme measurement method of the present technology may be an enzyme measurement method including a mixed liquid preparation step in which a mixed liquid including a plurality of kinds of enzymes and a plurality of kinds of selective substrates corresponding to the plurality of kinds of the enzymes is prepared; an array preparation step in which a microchamber array with immobilized metal nanostructures is prepared, the microchamber array having a plurality of microchambers in which metal nanostructures are immobilized; a mixed liquid sealing step in which the plurality of microchambers are sealed with the mixed liquid so that at least any one type of one or fewer molecules of the plurality of kinds of the enzymes is present in each of the plurality of microchambers; and a temporal change measuring step in which the microchamber array with immobilized metal nanostructures is illuminated with excitation light, and a surface-enhanced Raman scattering intensity derived from enzyme reaction products of the selective substrates or from the selective substrates is measured over time for each of the plurality of microchambers. Here, the enzyme reaction products have different structures from the selective substrates, and the enzyme reaction products and the selective substrates are distinguishable by a Raman peak. Further, a plurality of kinds of the enzyme reaction products have different structures from each other, and the plurality of kinds of the enzyme reaction products or the selective substrates are distinguishable by the Raman peak.

A basic example of the above-described second embodiment is different in that in the mixed liquid preparation step, the mixed liquid including the plurality of kinds of the enzymes and the plurality of kinds of selective substrates corresponding to the plurality of kinds of the enzymes is prepared; in the mixed liquid sealing step, the plurality of microchambers are sealed with the mixed liquid so that at least any one type of one or fewer molecules of the plurality of kinds of the enzymes is present in each of the plurality of microchambers; and in the temporal change measuring step, the plurality of kinds of the enzyme reaction products or the selective substrates are identified, but the other aspects are substantially the same as above.

### Third Embodiment

A third embodiment of the enzyme measurement method of the present technology is an enzyme measurement method including a mixed liquid preparation step in which a mixed liquid including an enzyme, a selective substrate for the enzyme, and a metal nanostructure is prepared; a droplet dividing step in which the mixed liquid is divided into a plurality of droplets so that one or fewer molecules of the enzyme is included in the droplet; and a bright spot counting step in which the plurality of droplets are illuminated with excitation light, and the number of droplets where a surface-enhanced Raman scattering intensity derived from an enzyme reaction product of the selective substrate or from the selective substrate has changed to a preset value or more, or is a preset threshold value or more or the threshold value or less is measured. Here, the enzyme reaction product has a different structure from the selective substrate, and the enzyme reaction product and the selective substrate are distinguishable by a Raman peak.

The first embodiment of the present technology is different in that a mixed liquid including an enzyme, a selective substrate for the enzyme, and a metal nanostructure is used, and the mixed liquid is divided into a plurality of droplets so that one or fewer molecules of the enzyme is included in the droplet, instead of filling the microchamber with the mixed liquid. Examples of the dividing method include a method in which a mixed liquid is injected into an oil with a jet to emulsify the mixed liquid.

Examples of the oil include inactive oils such as Fomblin, mineral oil, hexadecane, 3M Fluorinert FC-40, and 3M Fluorinert FC-70, but the oil is not limited thereto.

The Raman scattering intensity of each droplet may be measured two-dimensionally by spreading the droplets on a plane, or the droplets may be measured one-dimensionally one by one.

### Modified Example of Third Embodiment—Measurement of Plurality of Kinds of Enzymes

A third embodiment of the enzyme measurement method of the present technology may be an enzyme measurement method including a mixed liquid preparation step in which a mixed liquid including a plurality of kinds of enzymes and a plurality of kinds of selective substrates corresponding to the plurality of kinds of the enzymes is prepared; a droplet dividing step in which the mixed liquid is divided into a plurality of droplets so that at least any one type of one or fewer molecules of the plurality of kinds of the enzymes is included in the droplet; and a bright spot counting step in which the plurality of droplets are illuminated with excitation light, and the number of droplets where a surface-enhanced Raman scattering intensity derived from enzyme reaction products of the selective substrates or from the selective substrates has changed to a preset value or more, or is a preset threshold value or more or the threshold value or less is measured. Here, the enzyme reaction products have different structures from the selective substrates, and the enzyme reaction products and the selective substrates are distinguishable by a Raman peak. Further, a plurality of kinds of the enzyme reaction products have different structures from each other, and the plurality of kinds of the enzyme reaction products or the selective substrates are distinguishable by the Raman peak.

This modified example is an example in which the third embodiment is configured to correspond to a plurality of kinds of enzymes and substrates in the same manner as the modified example of the first embodiment.

### Fourth Embodiment

A fourth embodiment of the enzyme measurement method of the present technology includes a mixed liquid preparation step in which a mixed liquid including an enzyme, a selective substrate for the enzyme, and a metal nanostructure is prepared; a droplet dividing step in which the mixed liquid is divided into a plurality of droplets so that one or fewer molecules of the enzyme is included in the droplet; and a temporal change measuring step in which the plurality of droplets is illuminated with excitation light, and a surface-enhanced Raman scattering intensity derived from an enzyme reaction product of the selective substrate or from the selective substrate is measured over time for each of the plurality of droplets. Here, the enzyme reaction product has a different structure from the selective substrate, and the enzyme reaction product and the selective substrate are distinguishable by a Raman peak.

In the fourth embodiment, the bright spot counting step of the third embodiment is changed to a temporal change measuring step in which the surface-enhanced Raman scattering intensity derived from the enzyme reaction product is measured over time for each of the plurality of droplets. The other configurations are substantially the same as those of the third embodiment.

In the temporal change measuring step, the enzyme activity can be measured as a change in the scattering intensity per unit time by measuring the surface-enhanced Raman scattering intensity derived from the enzyme reaction product over time for each of the plurality of microchambers. By measuring the enzyme activity, for example, information on the multimerization degree of the enzyme can also be obtained.

### Modified Example of Fourth Embodiment—Measurement of Plurality of Kinds of Enzymes

A fourth embodiment of the enzyme measurement method of the present technology may be an enzyme measurement method including a mixed liquid preparation step in which a mixed liquid including a plurality of kinds of enzymes and a plurality of kinds of selective substrates corresponding to the plurality of kinds of the enzymes is prepared; a droplet dividing step in which the mixed liquid is divided into a plurality of droplets so that at least any one type of one or fewer molecules of the plurality of kinds of the enzymes is included in the droplet; and a temporal change measuring step in which the plurality of droplets is illuminated with excitation light, and a surface-enhanced Raman scattering intensity derived from enzyme reaction products of the selective substrates or from the selective substrates is measured over time for each of the plurality of droplets. Here, the enzyme reaction products have different structures from the selective substrates, and the enzyme reaction products and the selective substrates are distinguishable by a Raman peak. Further, a plurality of kinds of the enzyme reaction products have different structures from each other, and the plurality of kinds of the enzyme reaction products or the selective substrates are distinguishable by the Raman peak.

This modified example is an example in which the fourth embodiment is configured to correspond to a plurality of kinds of enzymes and substrates in the same manner as the modified example of the first embodiment.

### Kit

The present technology also provides a kit including the above-described SERS chip (microchamber array with immobilized metal nanostructures, the microchamber array having a plurality of microchambers in which metal nanostructures are immobilized) and a protocol that describes a procedure of the above-described enzyme measurement method according to the first or second embodiment. The present kit may include a standard reagent and the other components, in addition to the SERS chip and the protocol.

### Method for Capturing Raman Scattering Image

One embodiment of the method for capturing a Raman scattering image of the present technology is an method for capturing a Raman scattering image, the method including irradiating a sample with laser light expanded over an entire visual field by matching a transmission wavelength band of a narrow line-width bandpass filter to the top of a Raman peak of a target molecule to capture a Raman scattering image with a two-dimensional photodetector during the laser irradiation.

In the method for capturing a Raman scattering image of the present embodiment, the transmission wavelength band of the narrow line-width bandpass filter may further be matched to the bottom of the Raman peak of the target molecule.

In the method for capturing a Raman scattering image of the present embodiment, it is preferable that target molecules be arranged in a plurality of microchambers of a microchamber array having the plurality of microchambers.

In the microchamber array, it is preferable that the metal nanostructures be immobilized in the plurality of microchambers.

It is preferable that as the microchamber array, for example, the above-described microchamber array of the present technology be used, and the target molecules be arranged in each microchamber.

In the method for capturing a Raman scattering image of the present embodiment, it is preferable that the target molecules be arranged on the metal nanostructure.

The method for capturing a Raman scattering image of the present embodiment can be carried out, for example, in the same manner as in the above-described enzyme measurement method of the present technology.

As the narrow line-width bandpass filter, for example, the same filter as that used in the above-described enzyme measurement method of the present technology can be used.

Examples of the target molecule include the above-described enzyme, but the target molecule is not limited thereto.

### Method for Measuring Target Molecule

One embodiment of the method for measuring a target molecule of the present technology is a method for measuring a target molecule using Raman scattering, the method including irradiating a sample with laser light expanded over an entire visual field by matching a transmission wavelength band of a narrow line-width bandpass filter to the top of a Raman peak of a target molecule to capture a Raman scattering image with a two-dimensional photodetector during the laser irradiation; and extracting a density distribution of the target molecule from the obtained Raman scattering image.

In the method for measuring a target molecule of the present embodiment, the transmission wavelength band of the narrow line-width bandpass filter may further be matched to the bottom of the Raman peak of the target molecule.

In the method for measuring a target molecule of the present embodiment, it is preferable that the density distribution of the target molecule be extracted by taking a difference between Raman scattering images captured in the transmission wavelength band of the top and a transmission wavelength band of the bottom of the Raman peak of the target molecule.

In the method for measuring a target molecule of the present embodiment, it is preferable that the target molecules be arranged in a plurality of microchambers of a microchamber array having the plurality of microchambers.

In the microchamber array, it is preferable that the metal nanostructures be immobilized in the plurality of microchambers.

It is preferable that as the microchamber array, for example, the above-described microchamber array of the present technology be used, and the target molecules are arranged in each microchamber.

In the method for measuring a target molecule of the present embodiment, it is preferable that the target molecules be arranged on a metal nanostructure.

The method for measuring a target molecule of the present embodiment can be carried out, for example, in the same manner as in the above-described enzyme measurement method of the present technology.

As the narrow line-width bandpass filter, for example, the same filter as that used in the above-described enzyme measurement method of the present technology can be used.

Examples of the target molecule include the above-described enzyme, but the target molecule is not limited thereto.

### Application of Present Technology

The present technology can be suitably applied to a liquid biopsy. Specifically, for example, by measuring an enzyme in a liquid component such as blood, it is possible to obtain detailed information on cancer in a human more rapidly and less invasively. Examples of the cancer-related enzyme include thymidine kinase and galactose transferase.

### Advantages as Compared With Related Art

The present technology measures the enzyme concentration with ultrahigh sensitivity, in which a concept of digital detection is introduced into an SERS spectroscopy and the number of enzyme molecules is used as a vertical axis. In the related art, in the SERS spectroscopy, the concentration of a target molecule was quantified using the scattering light intensity as a vertical axis. However, the metal nanostructures need to be closely controlled, and it is difficult to ensure quantitativeness and reproducibility, particularly at low concentrations. In the present technology, by using the concept of digital detection in which the number of molecules is directly calculated from the number of bright spots, the enzyme concentration can be measured with high reproducibility and quantitativeness even at low concentrations of an order of femtomolar (fM=10⁻¹⁵ molar).

The present technology is unique in that a spectral measurement technology and a single-molecule measurement technology of a biological body are fused. In the related art, a fluorescent substrate was used for the activity measurement of one molecule of an enzyme. In the present technology, a substrate decomposition reaction of one molecule of the enzyme can be quantified in a plurality of units at the same time without labeling and with a narrow line-width spectrum by capturing Raman scattering light of the enzyme reaction product itself of the substrate. In addition, since labeling is not used, the present technology has an unprecedented advantage that the enzymes can be identified, in addition to removing a barrier of the activity inhibition by a fluorescent labeled substrate and expanding the measurable enzyme species.

### EXAMPLES

Hereinafter, the present invention will be described in more detail with reference to Examples. However, the present invention is not limited to Examples which will be described below.

### Manufacture of SERS Chip

### Manufacture of Microchamber Array (Steps S1 to S24)

Step S1: A cover glass of 24 mm×32 mm was placed on a glass stand and immersed in an 8 N aqueous potassium hydroxide solution.
Step S2: The glass was subjected to an ultrasonic treatment (90 minutes).
Step S3: The glass was let to stand (1 day).
Step S4: The glass was rinsed with pure water.
Step S5: The water droplets on the glass were removed by air blowing.
Step S6: A fluorine-based resin (9% of Cytop (fluorine-based resin, manufactured by AGC Inc.)) was added dropwise on the glass.
Step S7: The glass was spin-coated for 30 seconds at a rotation speed of 1,000 rpm.
Step S8: The glass was baked at 80° C. for 10 minutes and 180° C. for 1 hour.
Step S9: A positive tone photoresist (AZ P4620 (manufactured by AZ Electronic Materials)) was added dropwise on a glass coated with Cytop.
Step S10: The glass was spin-coated for 30 seconds at a rotation speed of 7,500 rpm.
Step S11: The glass was baked at 100° C. for 5 minutes.
Step S12: The glass was left to stand (5 minutes or longer, a humidity of 60% or higher).
Step S13: A chrome mask (holes having a diameter of 1.8 μm were arranged in an array at a pitch of 8 μm) was attached to a glass coated with a resist.
Step S14: The glass was exposed to ultraviolet rays for 20 seconds.
Step S15: The cover glass after the exposure was placed vertically on a glass stand and immersed in a developer (AZ300 MIF (manufactured by AZ Electronic Materials)) for 90 seconds.
Step S16: The glass was rinsed with pure water.
Step S17: The glass was subjected to dry etching by a reactive ion etching (RIE) device using an oxygen gas (exposed Cytop without resist protection was removed on the glass).
Step S18: The cover glass was placed on a glass stand and immersed in acetone (for removing the resist).
Step S19: The glass was subjected to an ultrasonic treatment (90 seconds).
Step S20: The glass was immersed in isopropanol.
Step S21: The glass was left to stand (90 seconds).
Step S22: The glass was rinsed with pure water.
Step S23: The water droplets on the glass were removed by air blowing.
Step S24: The diameter and the depth of the hole of Cytop were confirmed with a laser microscope.

The rotation speed in Step S7 was adjusted to be between 1,000 and 7,500 rpm.

The rotation speed in Step S10 was adjusted to be between 1,000 and 7,500 rpm.

The diameter and the pitch of the photo mask in Step S13 were not limited to the above-described values.

The chamber in Step S24 was assumed to have a diameter in the range of 0.1 to 100 μm and a depth in the range of 0.01 to 100 μm. The volume in this case was approximately 1 aL to 1 nL. In the example above, a microchamber array having a diameter of 3.2 μm, a depth of 1.6 μm, and a pitch of 8 μm was used. The volume of the microchamber was about 13 fL.

Hereinafter, the microchamber array manufactured by the above-described procedure may be referred to as a “device”.

### Immobilization of Metal Nanoparticles (Steps 1 to 21)

### Hydrophilization Treatment of Glass

Step 1: The device was placed on a glass stand and immersed in a 4 N aqueous potassium hydroxide solution.
Step 2: The device was subjected to an ultrasonic treatment (20 minutes).
Step 3: The device was left to stand (20 minutes).
Step 4: The device was rinsed with Milli-Q water.

### APTES Treatment of Glass

Step 5: The water droplets on the top were removed by air blowing.
Step 6: The device from which the water droplets were removed was placed on a glass stand and immersed in acetone.
Step 7: The device was taken out from the acetone and immersed in acetone in which 0.2% of 3-aminopropyltriethoxysilane (APTES) was dissolved.
Step 8: The device was left to stand (1 hour).
Step 9: The device was taken out from the APTES solution and immersed in acetone to be rinsed (twice).
Step 10: The device was taken out from acetone and left to stand (10 minutes).

### Washing of APTES-Treated Glass

Step 11: The glass was immersed in ethanol.
Step 12: The glass was subjected to an ultrasonic treatment (10 minutes).
Step 13: The glass was rinsed with Milli-Q water.
Step 14: The glass was immersed in Milli-Q water.
Step 15: The glass was subjected to an ultrasonic treatment (5 minutes).

### Formation of Aggregate of Silver Nanoparticles and Immobilization of Aggregate on Device

Step 16: Water droplets on the device were removed by air blowing.
Step 17:20 μL of a 40 nm silver nanoparticle dispersion and 20 μL of 0.03% trifluoroacetic acid (TFA) were mixed with each other and added dropwise on the device (TFA was added to accelerate the formation of an aggregate of the silver fine particles).
Step 18: The device was stored on an aluminum block cooled on ice while the liquid droplets were placed thereon.
Step 19: The device was left to stand (1 minute).
Step 20: The device was stored in a high-humidity and light-shielding box while the liquid droplets were placed thereon, and stored in a refrigerator (4° C.).
Step 21: The device was left to stand (1 day or longer). The manufacture of an SERS chip was completed.

The silver nanoparticle dispersion of Step 17 is assumed to have a diameter of 1 to 1,500 nm. As other metals, gold, copper, platinum, palladium, aluminum, titanium, or the like can also be used. In addition, an alloy, a core-shell structure, or the like can also be used. As the shape of the metal nanoparticle, a spherical shape, a rod shape, an elliptical shape, a triangular shape, a cubic shape, a bipyramidal shape, a star shape, or the like can be used.

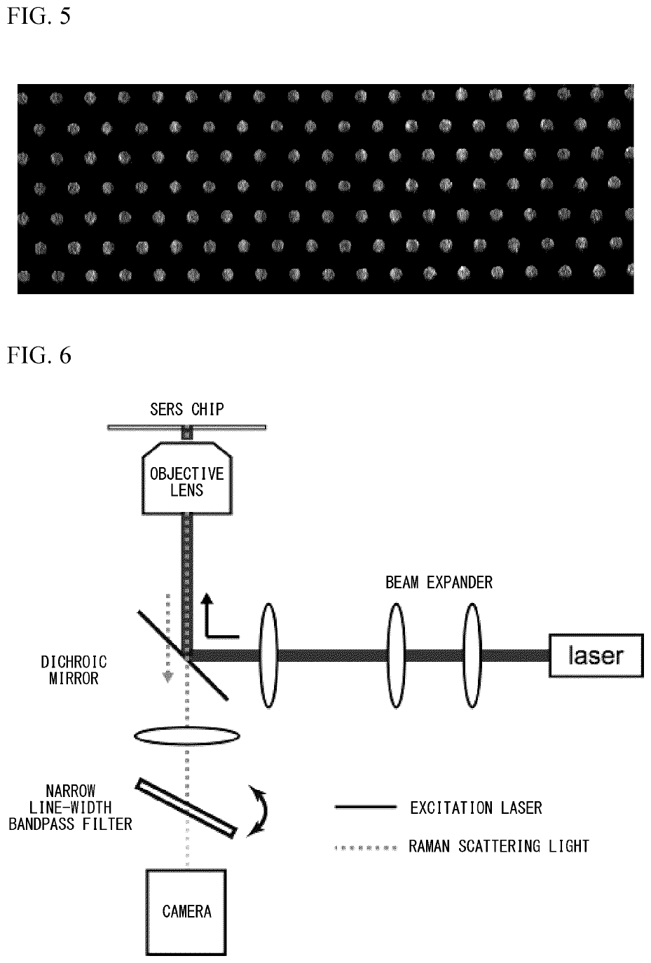

FIG. 5 is a scattering image of an SERS chip in which an aggregate of silver nanoparticles is immobilized in the microchamber array.

### Filling of One Molecule of Enzyme in SERS Chip (Steps 22 to 26)

### Filling of Enzyme in SERS Chip

Step 22: The liquid droplets on the SERS chip were removed.
Step 23: 40 μL of a mixed liquid of an enzyme, a substrate, and a surfactant was added dropwise to positions where the liquid droplets were present.
Step 24: 40 μL of oil was added dropwise thereto.
Step 25: The mixed liquid was absorbed with filter paper.
Step 26: The mixture was left to stand (for 20 minutes or longer).

The surfactant in Step 23 was 100 μM of Triton-X in the present example. Other surfactants can also be used without any particular limitation.

The oil in Step 24 was Fomblin in the present example. Other oils can also be used without particular limitation. For example, as the oil, mineral oil, hexadecane, 3M Fluorinert FC-40 (manufactured by 3M Company), 3M Fluorinert FC-70 (manufactured by 3M Company), or the like can also be used, in addition to Fomblin.

In Step 25, in addition to the absorption with the filter paper, a method in which a solution is sucked with a pipette, a method in which an oil is swept away through a flow channel, or the like can be used without particular limitation.

### Observation by Raman Microscope (Steps 27 to 41)

### Raman Measurement of SERS Chip in Which Enzyme Is Filled—Case of Wide-Field Raman Microscope

Step 27: The SERS chip was installed on a sample stage of a microscope.
Step 28: The focal point of the objective lens was matched with the bottom surface of the microchamber.
Step 29: The angle of the narrow line-width bandpass filter was adjusted and the transmission wavelength band was matched with the top of the Raman peak of the reaction product.
Step 30: The sample was irradiated with laser light expanded over the entire visual field.
Step 31: During the laser irradiation, a scattering image of the SERS chip was captured with a two-dimensional photodetector (a CMOS camera, a CCD camera, or the like).
Step 32: The irradiation with the laser light and the exposure of the two-dimensional photodetector were stopped.
Step 33: The angle of the narrow line-width bandpass filter was adjusted and the transmission wavelength band was matched with the bottom (tail) of the Raman peak of the reaction product.
Step 34: The sample was irradiated with the laser light expanded over the entire visual field (the same irradiation time as in Step 30).
Step 35: During the laser irradiation, the scattering image of the SERS chip was captured with a two-dimensional photodetector (a CMOS camera, a CCD camera, or the like) (the same exposure time as in step 31).
Step 36: The irradiation with the laser light and the exposure of the two-dimensional photodetector were stopped.
Step 37: The sample stage of the microscope was moved.
Step 38: Steps 29 to 37 were repeated (in Step 37, the sample stage was moved in a tile shape).

The imaging areas of Steps 31 and 34 are preferably 100 μm² to 10 mm². In the present example, the area was 60 μm×135 μm=8,100 μm².

The exposure time of the detector in Steps 31 and 34 is preferably 1 millisecond to 100 seconds. In the present example, the time was 2 seconds.

In Step 37, in the present example, the scanning was performed 30 times at a pitch of 60 μm in the longitudinal direction and 9 times at a pitch of 135 μm in the lateral direction, and 270 locations in total were imaged.

In a case of measuring two kinds of enzymes, Steps 29 to 32 were additionally performed once again (a peak top 1, a peak top 2, a beak bottom 1, and a beak bottom 2). In a case where two kinds of reaction products had peaks close to each other and had a common bottom, the bottom may not be imaged again.

FIG. 6 is an optical-system schematic view of a wide-field Raman microscope.

### Analysis of SERS Measurement Results—Case of Wide-Field Microscope

Step 39: A difference between the images captured in Step 30 (peak top) and Step 32 (beak bottom) was taken for each position of the sample table.
Step 40: The images of the difference acquired in Step 39 were arranged in a tile shape in accordance with the movement order of the sample stage.
Step 41: The number of microchambers (bright spots) brighter than the set threshold value was counted.

### Raman Measurement of SERS Chip in Which Enzyme Is Filled—Case of Slit-Scanning Raman Microscope

Step 27-s: The SERS chip was installed on a sample stage of a microscope.
Step 28-s: The focal point of the objective lens was matched with the bottom surface of the microchamber.
Step 29-s: The sample was irradiated with the laser light formed in a line shape (y direction) (several milliseconds to several seconds).
Step 30-s: During the laser irradiation, a scattering spectrum image (y-λ) of the SERS chip was captured by a two-dimensional photodetector (a CMOS camera, a CCD camera, or the like) connected to the spectroscope (exposure time: several milliseconds to several seconds). λ represents a wavelength direction of the scattering spectrum.
Step 31-s: The irradiation with the laser light and the exposure of the two-dimensional photodetector were stopped.
Step 32-s: The sample stage of the microscope was moved in an orientation (x direction) perpendicular to the line of the laser.
Step 33-s: Steps 29-s to 32-s were repeated.

### Analysis of SERS Measurement Results—Case of Slit-Scanning Raman Microscope

Step 34-s: The scattering spectrum image (y-λ) acquired while scanning in the x direction was reconstructed into x-y-λ data.
Step 35-s: x-y-λ1 and x-y-λ3 in which the λ direction was matched with the top (λ1) and the bottom (λ3) of the Raman peak of the reaction product were extracted.
Step 36-s: A difference between x-y-λ1 and x-y-λ3 was taken.
Step 37-s: The number of microchambers (bright spots) brighter than the set threshold value was counted.

The scanning pitch (x direction) of the Step 32-s is 0.5 μm in the present example. In the present example, the length (y direction) of the line-shaped laser was 140 μm.

In a case of measuring two kinds of enzymes, x-y-λ1, x-y-λ2, and x-y-λ3 of the top (λ1), the top (λ2), and the bottom (λ3) of the Raman peaks were extracted in Step 35-s. Further, in Step 36-s, the difference between x-y-λ1 and x-y-λ3 and the difference between x-y-λ2 and x-y-λ3 were taken.

### Experimental Results

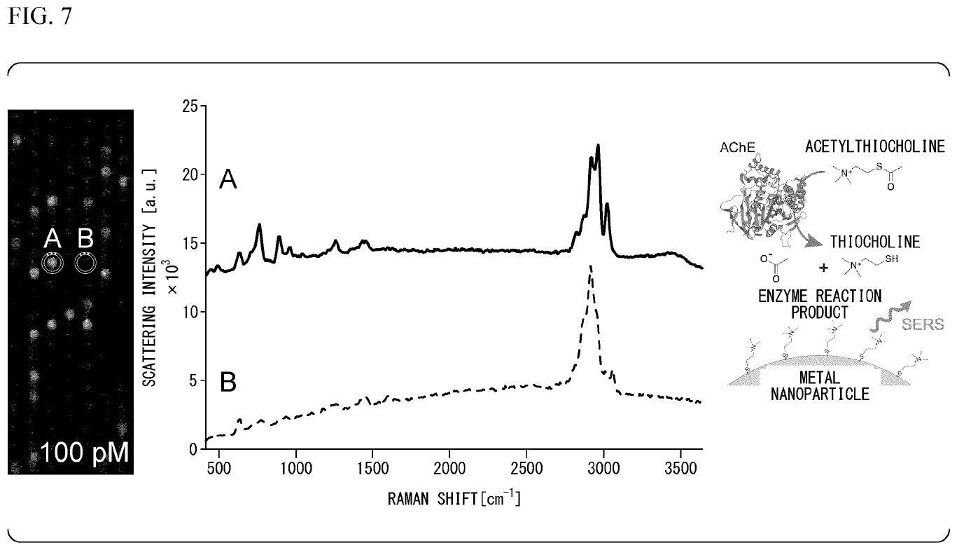

The experimental results are shown in FIGS. 7 to 11.

As shown in FIG. 7, the SERS spectrum derived from thiocholine, which is an enzyme reaction product, was detected in the chamber A, but was not detected in the chamber B.

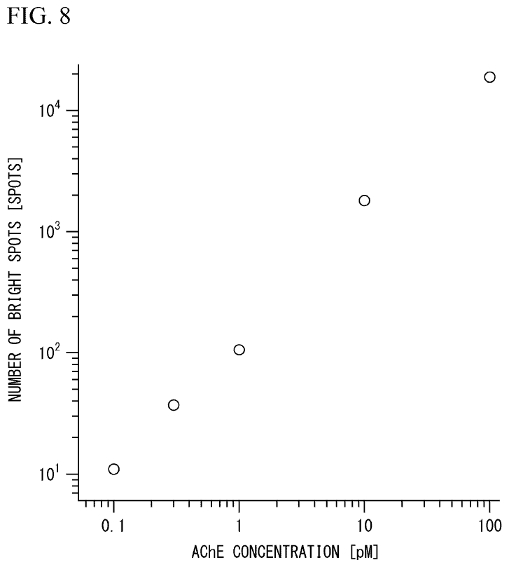

As shown in FIG. 8, it was shown that the number of bright spots increased depending on the concentration of acetylcholinesterase (AChE).

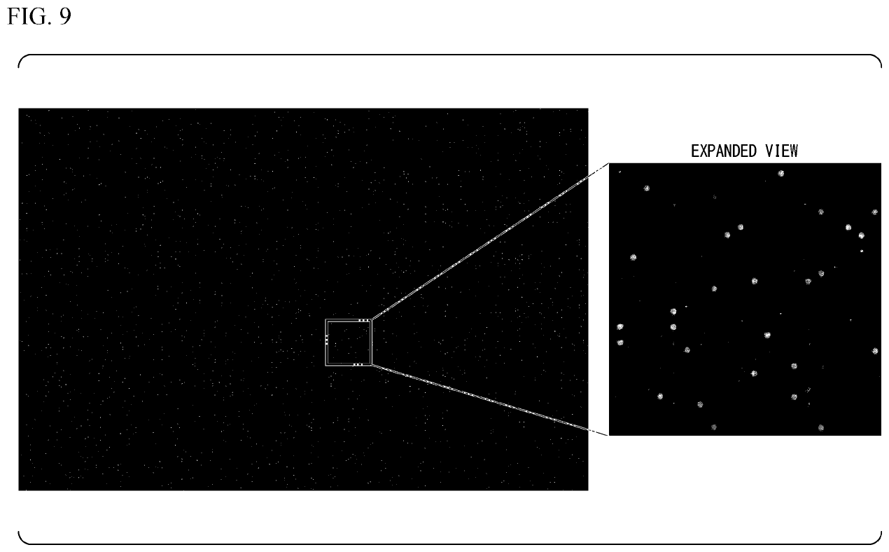

As shown in FIG. 9, even in a case where the wide-field Raman microscope was used, the SERS light (bright spot) derived from thiocholine, which is an enzyme reaction product, was observed in the same manner as in a case where the slit-scanning Raman microscope was used.

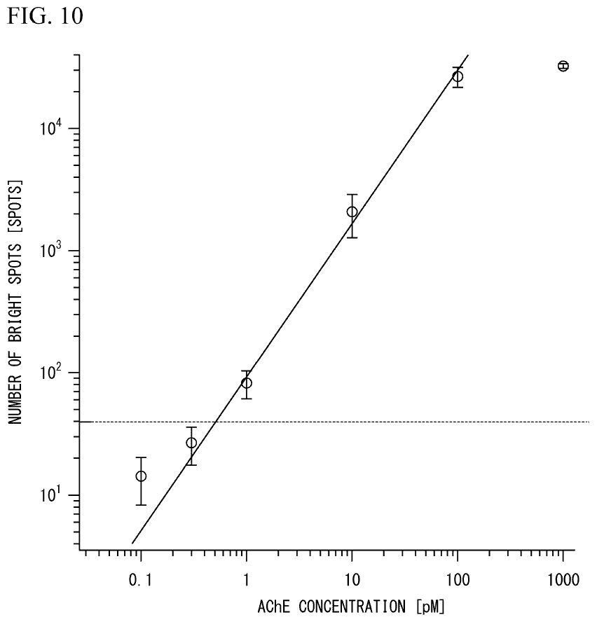

As shown in FIG. 10, it was shown that the number of bright spots increased depending on the concentration of acetylcholinesterase (AChE) as in the case of using the slit-scanning Raman microscope, even in a case of using the wide-field Raman microscope.

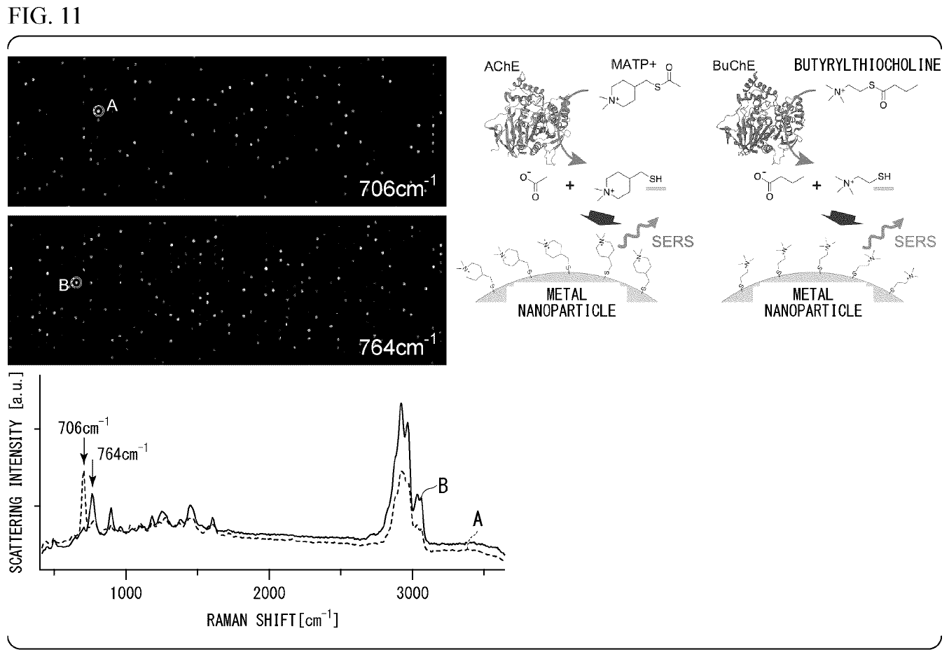

As shown in FIG. 11, the SERS spectrum derived from 1,1-dimethyl-4-mercaptomethyl piperidinium, which is an enzyme reaction product of acetylcholinesterase, and thiocholine, which is an enzyme reaction product of butyrylcholinesterase, were observed in the microchamber in which the SERS spectra were different from each other.

From the above, according to the present technology, it was shown that the enzyme in the sample could be detected without labeling with high sensitivity. In addition, it was also shown that a plurality of enzyme activities could be simultaneously identified and quantified by using substrates having different reactivities.

### INDUSTRIAL APPLICABILITY

In a living body, thousands of enzymes are present and express biological functions such as metabolism and absorption. Since abnormality of enzyme activity sensitively reflects diseases such as organ dysfunction, inflammation, and neurodegeneration, the abnormality is promising as an indicator of early disease diagnosis. In the present invention, it is possible to provide a highly sensitive single-molecule measurement method capable of fusing SERS spectroscopy and fine processing technology to quantify a trace enzyme concentration in a sample with high sensitivity and without labeling. In particular, in a case where a microchamber array (SERS chip) provided with a metal nanostructure is used, a reaction product is directly captured from SERS light (bright spot) for each chamber which is filled with one molecule of an enzyme, and the enzyme concentration in a sample can be quantified with high sensitivity by the digital counting of bright spots. Therefore, the enzyme activity (decomposition of a substrate) can be captured quantitatively for each molecule. Furthermore, by using substrates having different reactivities, a plurality of kinds of enzyme activities can be simultaneously identified and quantified. According to the present invention, it is possible to quantify an enzyme concentration in a sample that could not be examined due to insufficient sensitivity and identification ability, thereby contributing to medical and biological research.

### REFERENCE SIGNS LIST

100: High-speed Raman spectroscopic imaging apparatus
101: Laser light source
102, 106, 110: Optical path switching flip mirror
103, 108: Mirror
104: Cylindrical lens
105, 107, 111, 117: Lens
109: Dichroic filter
114: Slit
115: Spectroscope
116: CCD
118: Narrow line-width bandpass filter
119: sCMOS
112: Objective lens
113: Sample
510: Substrate
530: Well
700: Film
710: Resist film

What is claimed is:

1. An enzyme measurement method, comprising:
a mixed liquid preparation step in which a mixed liquid including an enzyme and a selective substrate for the enzyme, or including a plurality of types of enzymes and a plurality of types of selective substrates corresponding to the plurality of types of the enzymes is prepared;
an array preparation step in which a microchamber array with immobilized metal nanostructures is prepared, wherein the microchamber array has a plurality of microchambers in which metal nanostructures are immobilized;
a mixed liquid sealing step in which each of the plurality of microchambers is sealed with the mixed liquid so that one or fewer molecules of the enzyme, or at least any one type of one or fewer molecules of the plurality of types of the enzymes is present in each of the plurality of microchambers; and
a bright spot counting step in which the microchamber array with immobilized metal nanostructures is illuminated with excitation light, and the number of microchambers in which a surface-enhanced Raman scattering intensity derived from an enzyme reaction product of the selective substrate or from the selective substrate has changed to a preset value or more, or is a preset threshold value or more or the threshold value or less is measured,
wherein the enzyme reaction product has a different structure from the selective substrate, and the enzyme reaction product and the selective substrate are distinguishable by a Raman peak.

2. The enzyme measurement method according to claim 1, wherein in the bright spot counting step is a temporal change measuring step in which the microchamber array with immobilized metal nanostructures is illuminated with excitation light, and a surface-enhanced Raman scattering intensity derived from an enzyme reaction product of the selective substrate or from the selective substrate is measured over time for each of the plurality of microchambers.

3. (canceled)

4. (canceled)

5. (canceled)

6. (canceled)

7. An enzyme measurement method, comprising:
a mixed liquid preparation step in which a mixed liquid including an enzyme, a selective substrate for the enzyme, and a metal nanostructure or including a plurality of kinds of enzymes, a plurality of kinds of selective substrates corresponding to the plurality of kinds of the enzymes, and a metal nanostructure is prepared;
a droplet dividing step in which the mixed liquid is divided into a plurality of droplets so that one or fewer molecules of the enzyme or at least any one type of one or fewer molecules of the plurality of kinds of the enzymes is included in the droplet; and
a bright spot counting step in which the plurality of droplets are illuminated with excitation light, and the number of droplets where a surface-enhanced Raman scattering intensity derived from enzyme reaction products of the selective substrates or from the selective substrates has changed to a preset value or more, or is a preset threshold value or more or the threshold value or less is measured,
wherein the enzyme reaction products have different structures from the selective substrates, and the enzyme reaction products and the selective substrates are distinguishable by a Raman peak, and
a plurality of kinds of the enzyme reaction products have different structures from each other, and the plurality of kinds of the enzyme reaction products or the selective substrates are distinguishable by the Raman peak.

8. The enzyme measurement method according to claim 7, wherein in the bright spot counting step is a temporal change measuring step in which the plurality of droplets are illuminated with excitation light, and a surface-enhanced Raman scattering intensity derived from enzyme reaction products of the selective substrates or from the selective substrates is measured over time for each of the plurality of droplets,

9. The enzyme measurement method according to claim 1,
wherein in the bright spot counting step or the temporal change measuring step, the microchamber array with immobilized metal nanostructures where each microchamber is sealed with the mixed liquid is illuminated with wide-field illumination, a Raman scattering image is acquired in a wavelength band of the Raman peak of the enzyme reaction product or the selective substrate, using a narrow line-width bandpass filter adapted to a position of the Raman peak, and a surface-enhanced Raman scattering light intensity and a temporal change in the intensity of each microchamber are quantified.

10. The enzyme measurement method according to claim 9,
wherein Raman scattering images are acquired in a top wavelength band of the Raman peak of the enzyme reaction product or the selective substrate and in the bottom wavelength band of the Raman peak, and the surface-enhanced Raman scattering light intensity and the temporal change in the intensity of each microchamber are quantified by taking a difference between the two images.

11. The enzyme measurement method according to claim 1,
wherein in the bright spot counting step or the temporal change measuring step, the plurality of droplets obtained by dividing the mixed liquid are illuminated with wide-field illumination, a Raman scattering image is acquired in a wavelength band of the Raman peak of the enzyme reaction product or the selective substrate, using a narrow line-width bandpass filter adapted to a position of the Raman peak, and a surface-enhanced Raman scattering light intensity of each droplet is quantified.

12. The enzyme measurement method according to claim 11,
wherein Raman scattering images are acquired in a top wavelength band of the Raman peak of the enzyme reaction product or the selective substrate and in the bottom wavelength band of the Raman peak, and the surface-enhanced Raman scattering light intensity of each droplet is quantified by taking a difference between the two images.

13. The enzyme measurement method according to claim 1, wherein
the enzyme reaction product has a thiol group,
the metal nanostructure is an aggregate of metal nanoparticles, and
the enzyme is at least one selected from the group consisting of acetylcholinesterase, butyrylcholinesterase, phospholipase, elastase, and amylase.

14. (canceled)

15. (canceled)

16. The enzyme measurement method according to claim 13,
wherein a selective substrate for the acetylcholinesterase is MATP+ and a selective substrate for the butyrylcholinesterase is butyrylthiocholine.

17. A microchamber array used for the enzyme measurement method according to claim 1 and, comprising
a plurality of microchambers in which metal nanostructures are immobilized.

18. The microchamber array according to claim 17,
wherein the metal nanostructure is an aggregate of metal nanoparticles.

19. A kit comprising:
the microchamber array comprising a plurality of microchambers in which metal nanostructures are immobilized; and
a protocol that describes a procedure of the enzyme measurement method according to claim 1.

20. (canceled)

21. (canceled)

22. (canceled)

23. (canceled)

24. (canceled)

25. A method for measuring a target molecule using Raman scattering, the method comprising:
irradiating a sample with laser light expanded over an entire visual field by matching a transmission wavelength band of a narrow line-width bandpass filter to the top of a Raman peak of a target molecule to capture a Raman scattering image with a two-dimensional photodetector during the laser irradiation; and
extracting a density distribution of the target molecule from the obtained Raman scattering image.

26. The method for measuring a target molecule according to claim 25, the method further comprising:
matching the transmission wavelength band of the narrow line-width bandpass filter to the bottom of the Raman peak of the target molecule.

27. The method for measuring a target molecule according to claim 25,
wherein the density distribution of the target molecule is extracted by taking a difference between Raman scattering images captured in the transmission wavelength band of the top and a transmission wavelength band of the bottom of the Raman peak of the target molecule.

28. The method for measuring a target molecule according to claim 27,
wherein target molecules are arranged in a plurality of microchambers of a microchamber array having the plurality of microchambers.

29. The method for measuring a target molecule according to claim 28,
wherein metal nanostructures are immobilized in the plurality of microchambers.

30. The method for measuring a target molecule according to claim 27,
wherein the target molecules are arranged on a metal nanostructure.

31. The enzyme measurement method according to claim 7,
wherein the enzyme reaction product has a thiol group,
the metal nanostructure is an aggregate of metal nanoparticles, and
the enzyme is at least one selected from the group consisting of acetylcholinesterase, butyrylcholinesterase, phospholipase, elastase, and amylase.

32. The enzyme measurement method according to claim 31,
wherein a selective substrate for the acetylcholinesterase is MATP+ and a selective substrate for the butyrylcholinesterase is butyrylthiocholine.
